(19) United States
(12) Patent Application Publication
(10) Pub. No.: US 2002/0092384 A1
(43) Pub. Date: Jul. 18, 2002

(54) Wrench having a grip with better strength

(76) Inventor: Hsieh Shih-Kuei, Taichung (TW)

Correspondence Address: DOUGHERTY & TROXELL, ONE SKYLINE PLACE, SUITE 1404, 5205 LEESBURG PIKE, FALLS CHURCH, VA, 22041, US

(21) Appl. No.: 09/727,577

(22) Filed: Dec. 4, 2000

(51) Int. Cl. B25B 13/00

(52) U.S. Cl. 81/125.1

(57) ABSTRACT

Wrench having a grip with better strength, including: a grip at least one end of which is formed with a holding section for wrenching a nut, a bolt, etc.; a first plane face axially formed on the grip, the first plane face being substantially parallel to a wrenching plane face defined by the holding section; and two second plane faces formed on two sides of the first plane face along the axis of the grip. The second plane faces and the first plane face contain a large angle. The second plane faces are formed along entire length of the grip, whereby the grip has better strength and can be easily held.

### BACKGROUND OF THE INVENTION

The present invention is related to a hand tool, and more particularly to a wrench having a grip which has better strength and can be easily held.

FIG. 1 shows a conventional wrench 10 having a grip 12 formed with recessed sections 14 on top and bottom faces. In the recessed sections 14, generally, numerals indicating dimension or a trademark or words describing the material of the wrench are punched. The recessed sections 14 serve to reinforce the grip 12. However, the recessed sections 14 are only formed on a part of the grip 12 and the section 15 free from the recessed section simply has a rectangular cross-section. Therefore, the section 15 has insufficient strength and tends to be broken.

FIG. 2 shows an existent wrench 16 having a grip 18 with a polished surface for enhancing appearance. Such wrench has strip-like cross-section and has a poor structural strength.

Moreover, the grips 12, 18 of the conventional wrenches 10, 16 have polished surfaces and is liable to slip from a user's hand. The lateral faces 13, 19 of the grips 12, 18 have thin thickness and contact with the user's hand by small area. As a result, the user's hand will suffer a greater stress and feel painful in operation. In addition, the conventional wrenches have metallic monotonous color and lack attractiveness or identification.

### SUMMARY OF THE INVENTION

It is therefore a primary object of the present invention to provide a wrench having a grip which has better strength.

It is a further object of the present invention to provide the above wrench which has slipproof effect.

It is still a further object of the present invention to provide the above wrench which can be easily held without painful feeling.

It is still a further object of the present invention to provide the above wrench which has attractiveness and identification effect.

The present invention can be best understood through the following description and accompanying drawings wherein:

### BRIEF DESCRIPTION OF THE DRAWINGS

FIG. 1 is a perspective view of a conventional wrench;

FIG. 2 is a perspective view of another type of convention al wrench;

FIG. 3 is a perspective view of a preferred embodiment of the wrench of the present invention;

FIG. 4 is a side view according to FIG. 3;

FIG. 5 is a cross-sectional view taken along line 5-5 of FIG. 3;

FIG. 6 shows the forming of the wrench of the present invention;

FIG. 7 is a cross-sectional view of another embodiment of the wrench of the present invention;

FIG. 8 is a perspective view of another embodiment of the wrench of the present invention;

FIG. 9 shows the forming of the wrench of FIG. 8;

FIG. 10 is a perspective view of still another embodiment of the wrench of the present invention;

FIG. 11 shows a using state of the wrench of FIG. 10;

FIG. 12 is a partially sectional view of still another embodiment of the wrench of the present invention; and

FIG. 13 is a diagram showing the force application state of the wrench of the present invention.

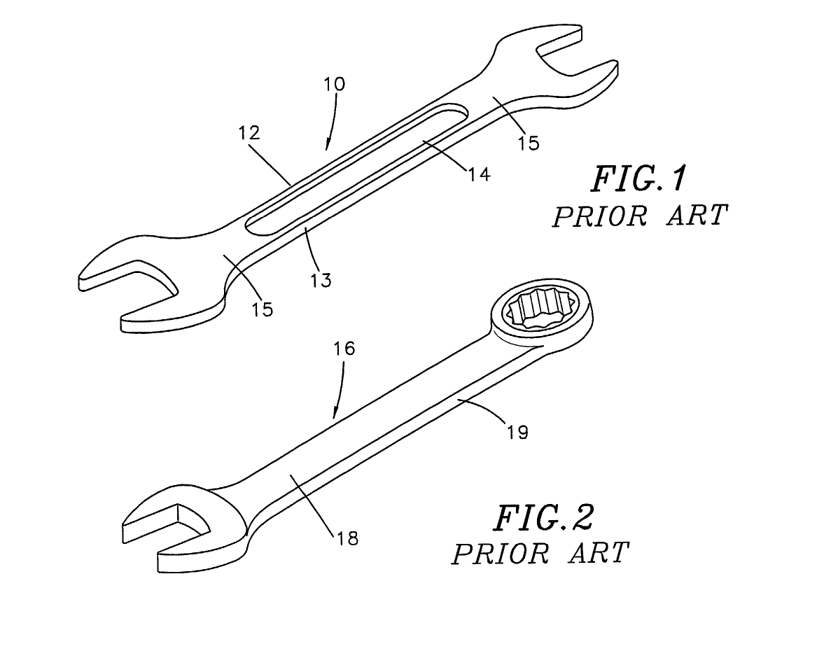

### DETAILED DESCRIPTION OF THE PREFERRED EMBODIMENTS

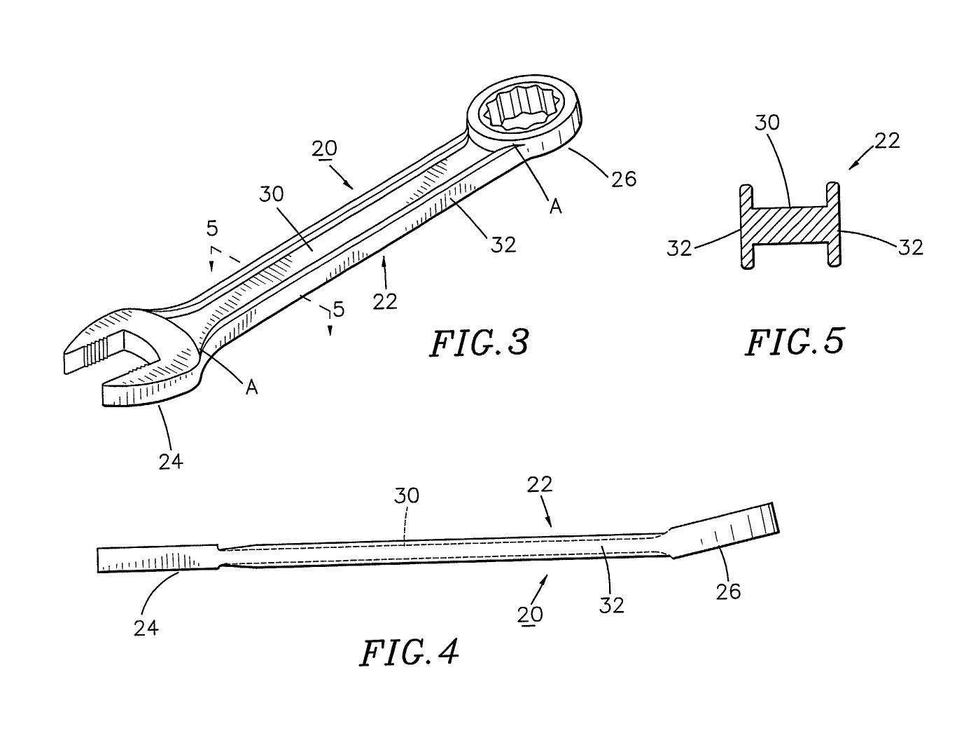

Please refer to FIG. 3. According to a preferred embodiment of the present invention, the wrench 20 includes a grip 22 two ends of which are respectively formed with two holding sections 24, 26 for wrenching a nut, a bolt or the like. One holding section 24 has an opening, while the other holding section 26 has a socket.

The grip 22 has a first plane face 30 substantially parallel to the wrenching plane face defined by the two holding sections 24, 26. The grip 22 further has two second plane faces 32 axially formed on two sides of the first plane face 30 along the grip 22. The second plane faces 32 and the first plane face 30 contain a large angle such as 90 degrees. The second plane faces 32 are formed along entire length of the grip with two ends respectively adjacent to the rear edges A of the two holding sections 24, 26. The top and bottom edges of the second plane faces 32 protrude from the first plane face 30 by a certain height as shown in FIG. 4. FIG. 5 shows the cross-section of the grip 22 at any part, which is H-shaped.

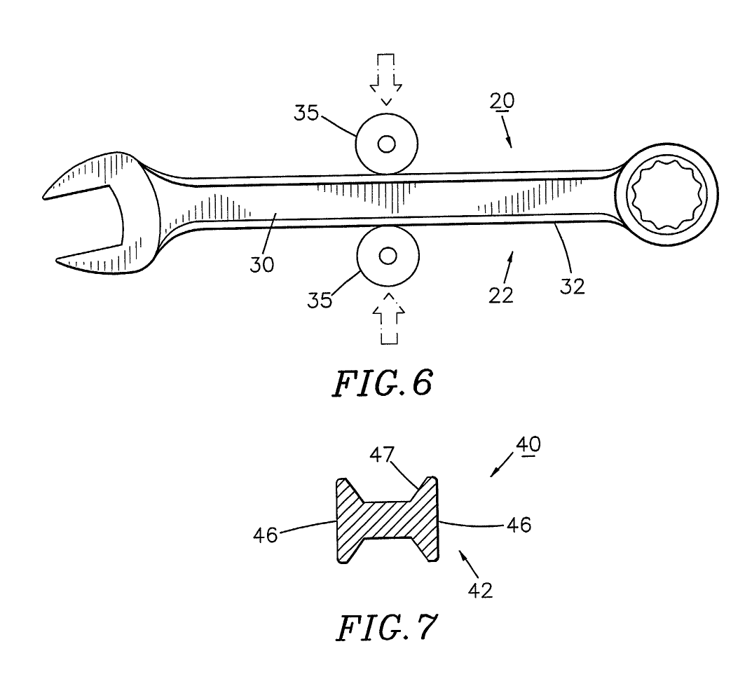

FIG. 6 shows the manner in which the two second plane faces 32 are formed. Two sides of the grip 22 are respectively rolled by two rollers 35 to form two second plane faces 32 on two sides of the first plane face 30.

In view of material mechanics, the two second plane faces 32 make the cross-section of the grip 22 become H-shaped (or I-shaped) and have better structural strength. Also, the entire length of the grip is formed with the second plane faces 32 so that the grip has uniform strength without weaker section which has poorer strength and tends to be damaged. Therefore, the wrench of the present invention has a strength better than that of the conventional wrench.

In addition, the two second plane faces 32 make the two sides of the grip 22 have larger contacting area with a user's hand. This facilitates holding of the wrench and reduces stress exerted onto the user's hand.

FIG. 7 shows the cross-section of another embodiment of the wrench 40 of the present invention. The inner walls of the second plane faces 46 of the grip 42 are slope faces 47 and the thickness of the second plane faces 46 is outward tapered. This makes the wrench have better strength.

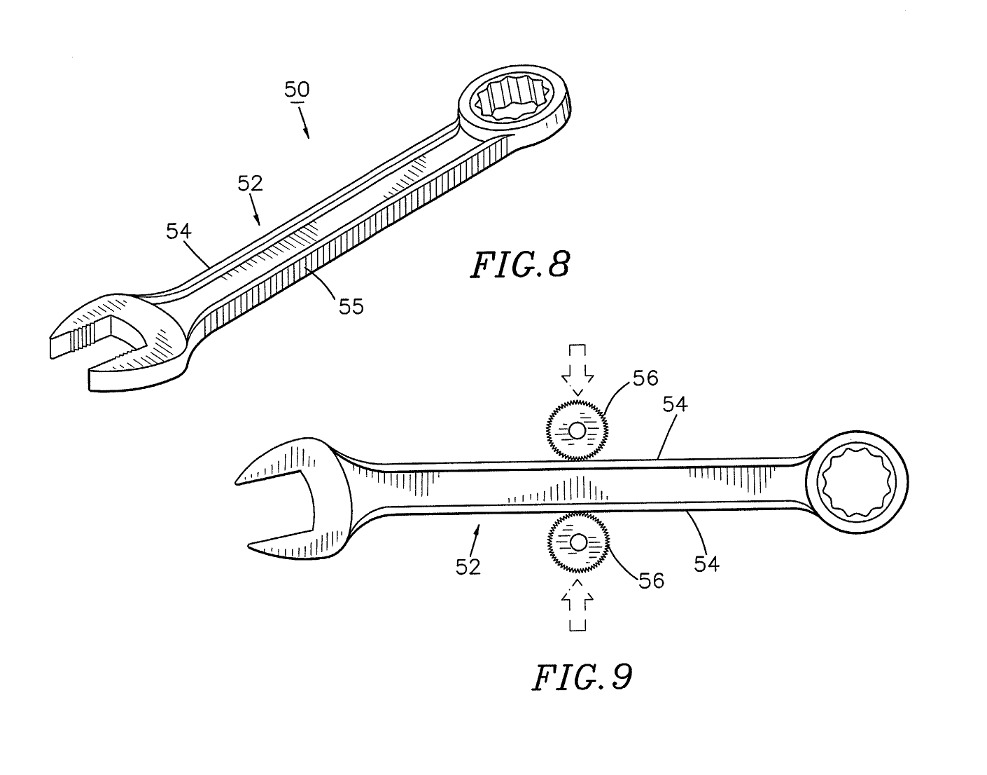

FIG. 8 shows still another embodiment of the wrench 50 of the present invention. The outer walls of the second plane faces 54 of the grip 52 are formed with projecting stripes 55. The projecting stripes 55 are formed in a manner as shown in FIG. 9. The rollers 56 have toothed surfaces for rolling and embossing two sides of the grip to form the second plane faces 54. The projecting stripes 55 provide sufficient frictional force to enhance the slipproof effect when holding the grip.

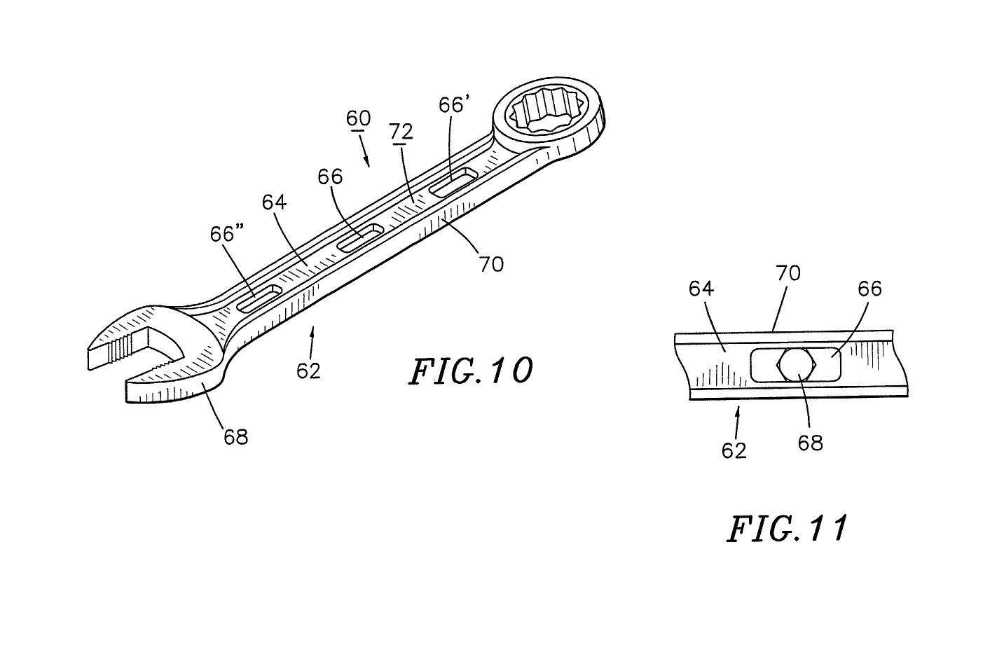

FIG. 10 shows still another embodiment of the wrench 60 of the present invention, in which the first plane face 64 of the grip 62 is formed with three through holes 66, 66′, 66″ having different widths which are different from the width of the opening of the holding section 68. The through holes 66 can be fitted with hexagonal or square nuts or bolts 68 with different sizes as shown in FIG. 11. Therefore, the wrench is versatile.

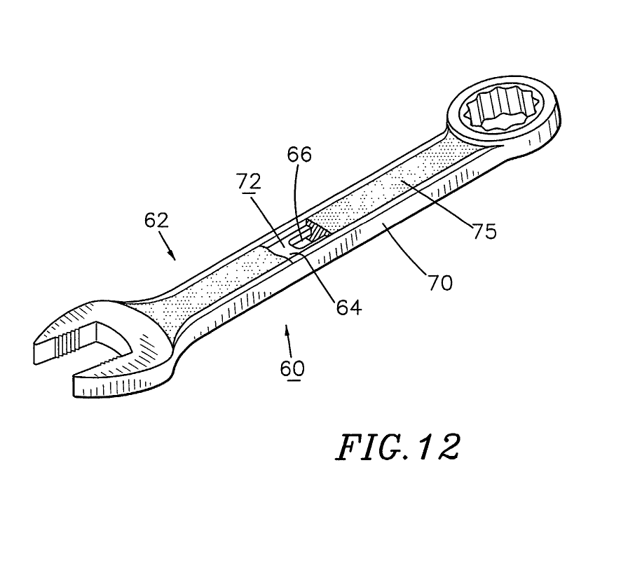

In addition, the first plane face 64 and the two second plane faces 70 of the grip 62 define two receptacles 72 on the top and bottom faces of the grip. Therefore, a slipproof material 75 can be filled or injected into the receptacles 72 as shown in FIG. 12. The slipproof material can be implanted in the through holes 66 to enhance the connection between the slipproof material and the grip.

The slipproof material 75 can be a soft material or a material with a certain hardness to make a user comfortably hold the grip 62. Also, the slipproof material 75 serves to prevent the wrench from slipping away from the user's hand.

In addition, the slipproof material can be formed with different colors instead of the monotonous metallic color of the conventional wrench so as to achieve an identification effect and visually attractive effect.

In conclusion, the wrench of the present invention has better structural strength and can be easily held with reduced stress exerted onto a user's hand. In addition, the wrench of the present invention can achieve a slipproof effect and have attractiveness and identification effect.

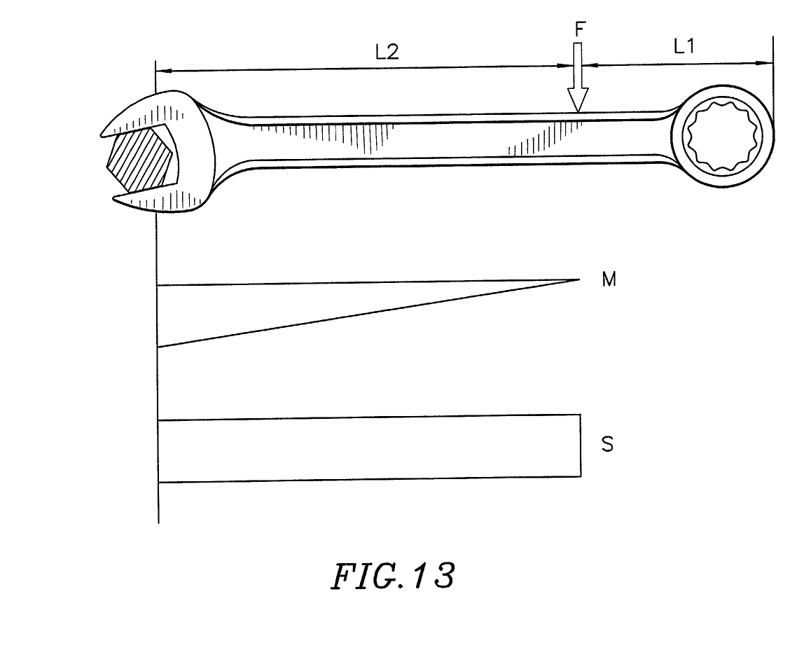

FIG. 13 shows the force application state of the present invention, wherein:

M: bending torque

δ: flexibility

F: action force

Y: Yang's coefficient

I: rotational inertia

S: shearing force

Mₘₐₓ=F×L₂

$$δ = \frac{{FL}_{2}^{3}}{3 YI} ( 1 + \frac{3 {L}_{1}}{2 {L}_{2}} )$$

The grip of the wrench of the present invention has uniform structural strength at every parts. When subject to a force, the grip only suffers bending torque and shearing stress. The cross-section of the grip is H-shaped or I-shaped so that it has better structural strength than the conventional wrench. Under the same strength, the wrench of the present invention has lighter weight and smaller volume than the conventional wrench.

The above embodiments are only used to illustrate the present invention, not intended to limit the scope thereof. Many modifications of the above embodiments can be made without departing from the spirit of the present invention.

What is claimed is:

1. Wrench having a grip with better strength, comprising:
a grip at least one end of which is formed with a holding section for wrenching a nut, a bolt, etc., the holding section defining a wrenching plane face; and
a first plane face axially formed on the grip, the first plane face having a cross-section substantially parallel to the wrenching plane face, the wrench being characterized in that the grip further has two second plane faces formed on two sides of the first plane face along the axis of the grip, the second plane faces and the first plane face containing a large angle, the second plane faces being formed along entire length of the grip, whereby the grip has better strength and can be easily held.

2. Wrench as claimed in claim 1, wherein the ends of the second plane faces are adjacent to rear edge of the holding section.

3. Wrench as claimed in claim 1, wherein at least one of the top edge and bottom edge of each of the second plane faces protrudes from the first plane face.

4. Wrench as claimed in claim 1, wherein outer walls of the second plane faces are formed with projecting stripes.

5. Wrench as claimed in claim 1, wherein the width of the cross-section of the portion of the second plane face protruding from the first plane face is outward tapered.

6. Wrench as claimed in claim 1, wherein the first plane face is formed with a predetermined number of through holes.

7. Wrench as claimed in claim 1, wherein the first plane face and the two second plane faces of the grip define at least one receptacle on the top or bottom face of the grip, a slipproof material being disposed in the receptacle.

8. Wrench as claimed in claim 6, wherein the first plane face and the two second plane faces of the grip define at least one receptacle on the top or bottom face of the grip, a slipproof material being disposed in the receptacle and implanted in the through holes.
